(19) United States
(12) Patent Application Publication
(10) Pub. No.: US 2017/0019399 A1
(43) Pub. Date: Jan. 19, 2017

(54) SECURE UPDATE PROCESSING OF TERMINAL DEVICE USING AN ENCRYPTION KEY STORED IN A MEMORY DEVICE OF THE TERMINAL DEVICE

(71) Applicant: KABUSHIKI KAISHA TOSHIBA, Tokyo (JP)

(72) Inventors: Atsushi YAMAZAKI, Hachioji Tokyo (JP); Kentaro UMESAWA, Kawasaki Kanagawa (JP); Teruji YAMAKAWA, Chuo Tokyo (JP)

(21) Appl. No.: 15/051,358

(22) Filed: Feb. 23, 2016

(30) Foreign Application Priority Data
Jul. 14, 2015 (JP) 2015-140557

(51) Int. Cl. H04L 29/06; H04L 9/32

(52) U.S. Cl. CPC H04L 63/0853; H04L 63/06; H04L 63/08; H04L 9/3247; H04L 9/3271; H04L 63/061

(57) ABSTRACT

An update processing is carried out on a terminal through communication with an external device connected therewith over a network. The terminal includes a processor configured to receive an update request from the external device, the update request including update data and challenge data, and a storage device in which original data to be updated and a private key are stored. The storage device is configured to update the original data using the update data and generate a digital signature of the challenge data using the private key. The processor is further configured to transmit the digital signature of the challenge data to the external device as a completion notification of the update processing.

### CROSS-REFERENCE TO RELATED APPLICATION

This application is based upon and claims the benefit of priority from Japanese Patent Application No. 2015-140557, filed Jul. 14, 2015, the entire contents of which are incorporated herein by reference.

### FIELD

Embodiments described herein relate generally to a storage device and a computing system including the same.

### BACKGROUND

A storage device may be coupled to a terminal device that is connected to a communication network such as the internet. Update processing of control program for the terminal device, e.g., firmware, is performed between a delivery serer and the terminal device connected through the communication network.

### DESCRIPTION OF THE DRAWINGS

FIG. 1 is a block diagram of a storage device according to a first embodiment.

FIG. 2 is a block diagram of a system including the storage device, a terminal device, and a delivery server according to the first embodiment.

FIG. 3 is a sequence diagram illustrating a firmware update operation according to the first embodiment.

FIG. 4 is a block diagram of a system including a storage device, a terminal device, and a delivery server according to a second embodiment.

FIG. 5 is a flowchart illustrating an example of an operation of the delivery server according to the second embodiment.

FIG. 6 is a block diagram of a storage device according to a third embodiment.

FIG. 7 is a block diagram of a system including the storage device, a terminal device, and a delivery server according to the third embodiment.

FIG. 8 is a sequence diagram illustrating a firmware update operation according to the third embodiment.

FIG. 9 is a block diagram of a storage device according to a fourth embodiment.

FIG. 10 is a sequence diagram illustrating a patch application operation according to the fourth embodiment.

### DETAILED DESCRIPTION

In general, according to an embodiment, a terminal for which update processing is carried out through communication with an external device connected therewith over a network, includes a processor configured to receive an update request from the external device, the update request including update data and challenge data, and a storage device in which original data to be updated and a private key are stored. The storage device is configured to update the original data using the update data and generate a digital signature of the challenge data using the private key. The processor is further configured to transmit the digital signature of the challenge data to the external device as a completion notification of the update processing.

Embodiments will be hereinafter described with reference to the accompanying drawings.

In the present disclosure, a plurality of expressions is used for some elements. These expressions are examples, and the elements may be expressed differently. In addition, elements that are described with a single expression may be expressed differently.

In addition, the drawings are schematic, and a relationship between a thickness and a plan dimension, a ratio of the thickness of each layer, or the like may be different from actual ones. In addition, a portion having a dimensional relationship or a ratio different from each other may be included in the drawings.

### First Embodiment

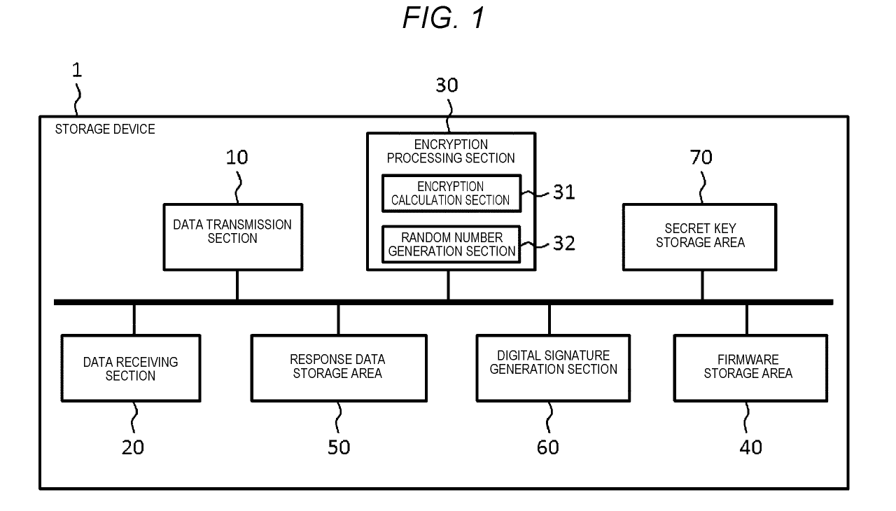

FIG. 1 is a block diagram of a storage device 1 according to a first embodiment. The storage device 1 is, for example, a hard disk drive (HDD), but is not limited thereto. The storage device 1 may be a solid state drive (SSD) or a combination of the HDD and the SSD.

The storage device 1 includes, as a functional section (or unit), a data transmission section 10, a data receiving section 20, an encryption processing section 30, a firmware storage area 40, a response data storage area 50, a digital signature generation section 60, and a secret key storage area 70. In addition, the encryption processing section 30 includes an encryption calculation section 31 and a random number generation section 32. These sections can be implemented in hardware or software (a processor executing programs for performing these functions).

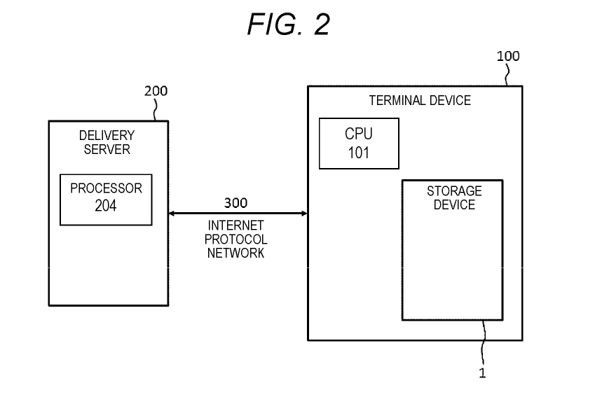

FIG. 2 illustrates a system including a terminal device (terminal apparatus) 100 that includes a central processing unit (CPU) 101 and the storage device 1, and a delivery server 200 that transmits data to the terminal device 100 under the control of a processor 204 installed in the deliver server 200. The terminal device 100 and the delivery server 200 are coupled to each other by an internet protocol (IP) network 300. Alternatively, the terminal device 100 and the delivery server 200 may be coupled to each other by other methods using, such as a 3G network, a 4G network, a long term evolution network (LTE)®, or a TV broadcast channel. In addition, in the present embodiment, the delivery server 200 causes the terminal device 100 to update the firmware thereof.

As described above, the storage device 1 is mounted in the terminal device 100. The terminal device 100 is a terminal such as a point of sale (POS) or multifunction peripheral (MFP), but is not limited to this, and may be a television, a recorder, a personal computer (PC), or the like. The CPU 101 of the terminal device 100 executes a program to carry out communications with the delivery server 200 and with the storage device 1. Meanwhile, the terminal device 100 may be referred to as an external apparatus of the storage device 1.

For example, when update of the firmware of the terminal device 100 is performed, the delivery server 200 delivers update data to the terminal device 100 through an IP network 300, together with firmware update requests.

In addition, when update of the terminal device 100 is completed, the delivery server 200 receives response data from the terminal device 100, which will be described below.

Returning to FIG. 1, the data transmission section 10 transmits data to the outside of the storage device 1. In the first embodiment, for example, the data transmission section 10 causes response data to be transmitted to the delivery server 200 through the terminal device 100, in response to data which is transmitted from the delivery server 200 through the terminal device 100.

The data receiving section 20 receives data from the outside of the storage device 1. In the present embodiment, for example, when the firmware of the terminal device 100 is updated, the data receiving section 20 receives update data from the delivery server 200 through the terminal device 100.

Here, for the sake of convenient description, the data transmission section 10 and the data receiving section 20 are exemplified as separate functional sections, but for example, a single data transmission and receiving section or an interface unit having functions of the data transmission section 10 and the data receiving section 20 may be used.

The encryption processing section 30 performs encryption processing of the data which is handled by the storage device 1. Specifically, the encryption calculation section 31 encrypts a digital signature which is added as authentication information to the data received by the storage device 1, using a secret, private key of the storage device 1 that is stored in the secret key storage area 70. The random number generation section 32 generates a random number for determining validity of data that is received by the data receiving section 20, for example, at each preset time.

Firmware data of the terminal device 100 and update data delivered from the delivery server 200 are stored in the firmware storage area 40.

Response data, which is generated in the storage device 1 and to be transmitted to the delivery server 200, is temporarily stored in the response data storage area 50.

The digital signature generation section 60 generates a digital signature of challenge data transmitted from the delivery server 200. Meanwhile, the digital signature is stored in the response data storage area 50 as response data.

The private key of the storage device 1, which is used when the digital signature generation section 60 generates a digital signature, is stored in the secret key storage area 70.

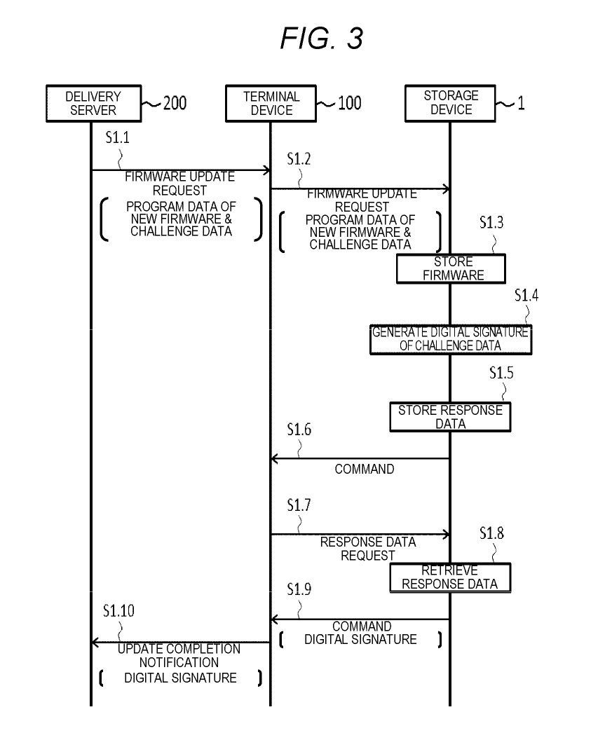

FIG. 3 is a sequence diagram of the firmware update operation according to the first embodiment. The firmware update operation to update the firmware of the terminal device 100 will be hereinafter described with reference to FIG. 3.

When the firmware of the terminal device 100 is updated, first the delivery server 200 issues a firmware update request for the terminal device 100 (S1.1). At this time, the delivery server 200 transmits the update data to the terminal device 100, together with the firmware update request.

Alternatively, the delivery server 200 may be configured to initially transmit only the firmware update request to the terminal device 100, receive a response from the terminal device 100 after the terminal device 100 confirms that the terminal device 100 is in an updatable state, and thereafter transmit the update data to the terminal device 100.

Hereinafter, it is assumed that the “firmware update request” includes the update data. Meanwhile, in the present embodiment, the “update data” includes program data of new firmware and challenge data.

The terminal device 100 transmits the firmware update request received from the delivery server 200 to the storage device 1 using, for example, a dedicated command (S1.2). The update data that is received through the data receiving section 20 of the storage device 1 is written to the firmware storage area 40 of the storage device 1. That is, program data of the new firmware is stored in the firmware storage area 40 (S1.3).

Subsequently, in the storage device 1, the digital signature generation section 60 generates a digital signature of the challenge data that is included in the update data, using the private key of the storage device 1 stored in advance in the secret key storage area 70 (S1.4). The generated digital signature and the challenge data are stored in the response data storage area 50 as the response data (S1.5). The storage device 1 completes processing according to the firmware update request, and returns a command to the terminal device 100 through the data transmission section 10 (S1.6).

In response to receiving the command from the storage device 1, the terminal device 100 issues a response data request to the storage device 1 (S1.7).

In response to receiving the response data request through the data receiving section 20, the storage device 1 retrieves the response data from the response data storage area 50 (S1.8), and transmits the response data (command) to the terminal device 100 through the data transmission section 10 (S1.9).

In response to receiving the command, the terminal device 100 issues update completion notification and transmits the notification to the delivery server 200 together with the response data (S1.10). By performing authentication of the digital signature included in the received response data, e.g., by decrypting the digital signature using a public key of the storage device 1 to obtain the challenge data and confirming that it matches the challenge data transmitted with the firmware update request in S1.1, the delivery server 200 may confirm that the firmware update of the terminal device 100 is correctly completed.

Here, challenge and response authentication that is performed between the delivery server 200 and the terminal device 100 will be described. The delivery server 200 transmits a firmware update request to the terminal device 100. The terminal device 100 receives the challenge data together with the firmware update request. Thereafter, if the delivery server 200 can receive the response data from the terminal device 100, the delivery server 200 may complete the challenge and response authentication, and determine that the firmware update is correctly performed.

However, for example, when the terminal device 100 is accessed from the outside without authorization, the firmware update completion can be falsified. More specifically, the terminal device 100 (which is accessed without authorization) may return the response data to the delivery server 200 without transmitting the new firmware to the storage device 1 and updating the firmware.

In addition, when the terminal device 100 is infected with virus or the like, the same problems as described above may occur. Furthermore, the update of the firmware may also be blocked by the terminal device 100.

To deal with this issue, in the present embodiment, the challenge and response authentication is performed between the delivery server 200 and the storage device 1.

In general, the storage device 1 includes a dedicated hardware which is independent from the terminal device 100. For this reason, unauthorized access or alteration from the outside may be prevented, as compared to the terminal device 100. By performing the challenge and response authentication between the storage device 1 and the delivery server 200, it is possible to more reliably confirm that the firmware update is correctly completed.

In addition, when the terminal device 100 receives an unauthorized access thereby performing an unauthorized operation, the delivery server 200 or the storage device 1 may detect that the firmware update has not been correctly performed. For this reason, it is possible to rapidly implement countermeasure, such as disconnection of the terminal device 100 from the IP network 300 or initialization of the terminal device 100 by a maintenance person. Furthermore, it is also possible to not start the firmware which may be accessed without authorization, when restarting the terminal device 100.

### Second Embodiment

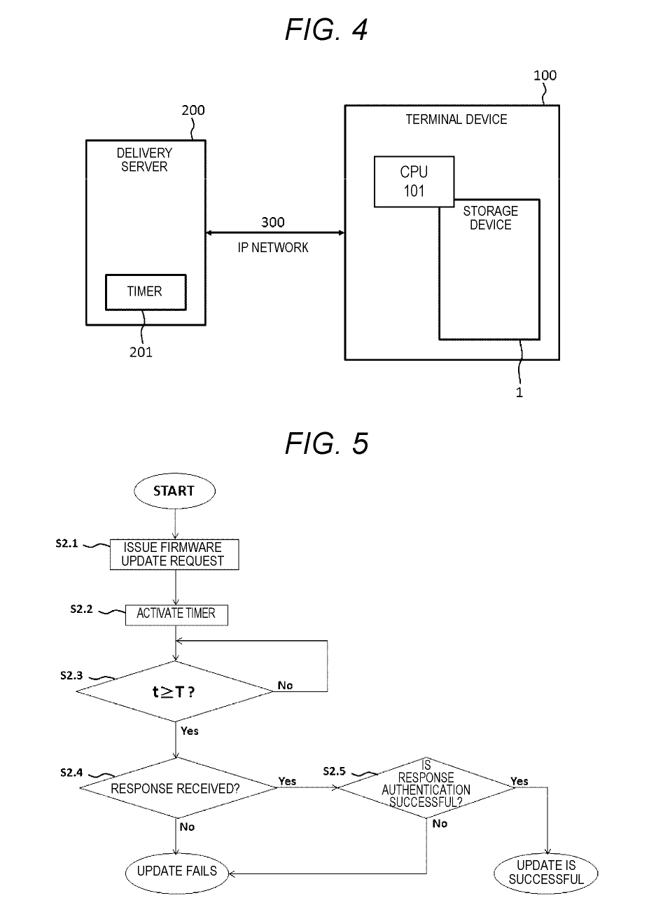

FIG. 4 illustrates a system including the terminal device 100 in which the storage device 1 is included, and the delivery server 200 according to a second embodiment. FIG. 5 is a flowchart illustrating an operation carried out by the delivery server 200 according to the second embodiment when the firmware of the terminal device 100 is updated. Here, in the present embodiment, the same symbols or reference numerals will be used for the same configuration elements as in the first embodiment, and detailed description thereof will be omitted.

In the present embodiment, the processor of the delivery server 200 is programmed as a timer 201, as illustrated in FIG. 4. The delivery server 200 starts the timer 201 along with the issuance of a firmware update request with respect to the terminal device 100. With this configuration, the delivery server 200 may determine that firmware update is not correctly performed, when response data (update completion notification) is not transmitted from the terminal device 100 within a predetermined time.

Here, the “predetermined time” may be a value which is set by an administrator of the delivery server 200, and may be appropriately modified according to a size of the update data (particularly, new firmware) which is transmitted together with the firmware update request, complexity of firmware update processing, or the like.

In general, it is preferable that the predetermined time which is set in the timer 201 when the update data is large, to be longer than that when the update data is small. This is because it takes more time to perform the firmware update as the size of the update data increases.

In addition, the predetermined time measured by the timer 201 may be changed according to the content of the firmware update processing. For example, in the case where only update data is added (that is written) to the firmware storage area 40 of the storage device 1, a time required for updating the firmware is shorter than the case where the firmware update replaces the entire firmware stored in the firmware storage area 40 with new firmware.

For example, when the storage device 1 is an HDD, if the existing data is changed, new data is added to the existing data. For this reason, a time required for writing the data is substantially the same as the time to write the data to a free area.

On the other hand, when the storage device 1 is an SSD, if the existing data needs to be changed, it is necessary to erase data that is no longer required. In general, a flash memory that is used for the SSD needs more time to erase data, as compared to writing data.

For example, for the firmware update, it is necessary to erase the firmware that is stored in the firmware storage area 40 prior to the update, and to store new update data in the firmware storage area 40. For this reason, it takes more time, as compared to when the data is written to a free area.

In general, writing speed to the SSD is faster than that to the HDD. Considering the difference in the writing speed, the “predetermined time” described above may be changed based on the type of the storage device 1.

FIG. 5 illustrates an example of an operation carried out by the delivery server 200 according to the present embodiment. When the firmware of the terminal device 100 is updated, first the delivery server 200 issues a firmware update request for the terminal device 100 (S2.1).

The delivery server 200 activates the timer 201 according to the issue of the firmware update request, and starts counting an elapsed time t (S2.2). Here, the sequence of the firmware update request and the start of the timer 201 may be reversed. It is preferable that the time between S2.1 and S2.2 is short in either case.

Thereafter, it is determined whether or not a predetermined time T has passed, after the firmware update request is issued (S2.3), and when t≧T is satisfied, it is determined whether or not a response from the terminal device 100 and the storage device 1 has been received (S2.4).

In S2.4, when a response has not been received from the terminal device 100 and the storage device 1 (No in S2.4), the delivery server 200 can determine that the firmware update fails.

In contrast, in S2.4, when a response has been received from the terminal device 100 and the storage device 1 (Yes in S2.4), the delivery server 200 performs response authentication in the same manner as in the first embodiment and determines whether or not the update is correctly performed based on the authentication result (S2.5).

When the response authentication is successful (Yes in S2.5), the delivery server 200 recognizes that the firmware update of the terminal device 100 is successful. Meanwhile, when the response authentication fails (No in S2.5), the delivery server 200 recognizes that the firmware update of the terminal device 100 fails.

In the configuration of the delivery server 200 described in the present embodiment, the delivery server 200 may recognize based on not only the result of the challenge and response authentication described in the first embodiment, but also determination result of whether or not the response is returned from the terminal device 100 and the storage device 1 within the predetermined time.

According to the configuration described above, for example, when the response data is not returned to the delivery server 200 even after the elapse of the predetermined time, it is estimated that the terminal device 100 is infected with virus or the like, or there was an unauthorized access, alteration, or the like to the terminal device 100 from the outside. As a result, it is possible to rapidly perform countermeasure, such as disconnection of the terminal device 100 from the IP network 300, or initialization of the terminal device 100 by a maintenance person.

Further, according to the present embodiment, the timer 201 does not need to be provided additionally in the delivery server 200 described in the first embodiment. That is, when a hardware configuration or a function included in the delivery server 200 contains a clock function, the function may be used as the timer 201.

### Third Embodiment

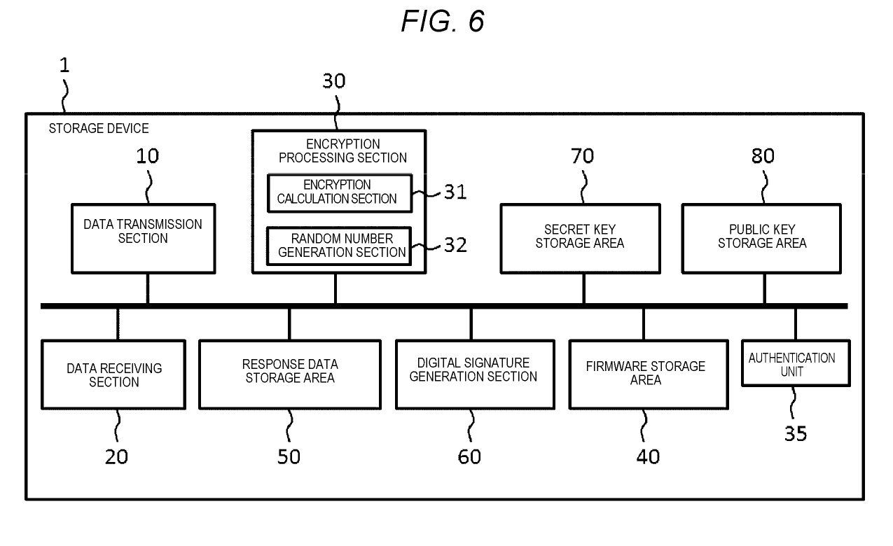

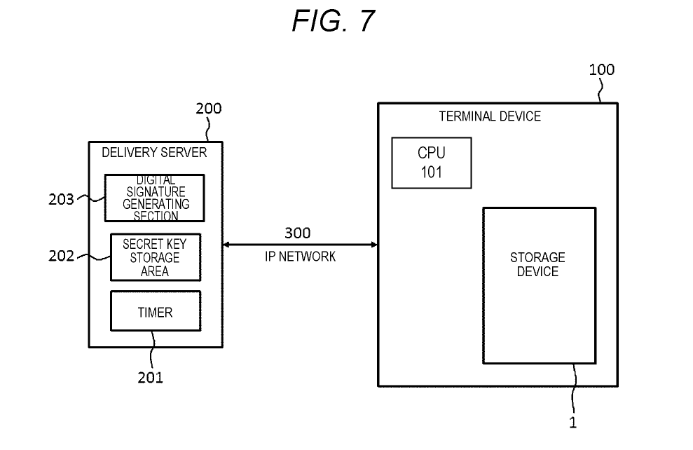

FIG. 6 is a block diagram of a storage device 1 according to a third embodiment. FIG. 7 illustrates a system including a terminal device 100 in which the storage device 1 according to the third embodiment is included and a delivery server 200. In the description of the third embodiment, the same symbols or reference numerals will be used for the same configuration elements as those of the first embodiment and the second embodiment, and description thereof will be omitted.

As described in FIG. 6, the storage device 1 includes a public key storage area 80, and a public key of the delivery server 200 is stored in the public key storage area 80.

In addition, the storage device 1 includes an authentication section 35. The authentication section 35 performs authentication using the public key stored in the public key storage area 80.

Furthermore, as illustrated in FIG. 7, the delivery server 200 includes a secret key storage area 202 and the processor of the delivery server 200 is programmed as a digital signature generating section 203. A secret, private key of the delivery server 200 is stored in the secret key storage area 202. The digital signature generating section 203 generates a digital signature for challenge data.

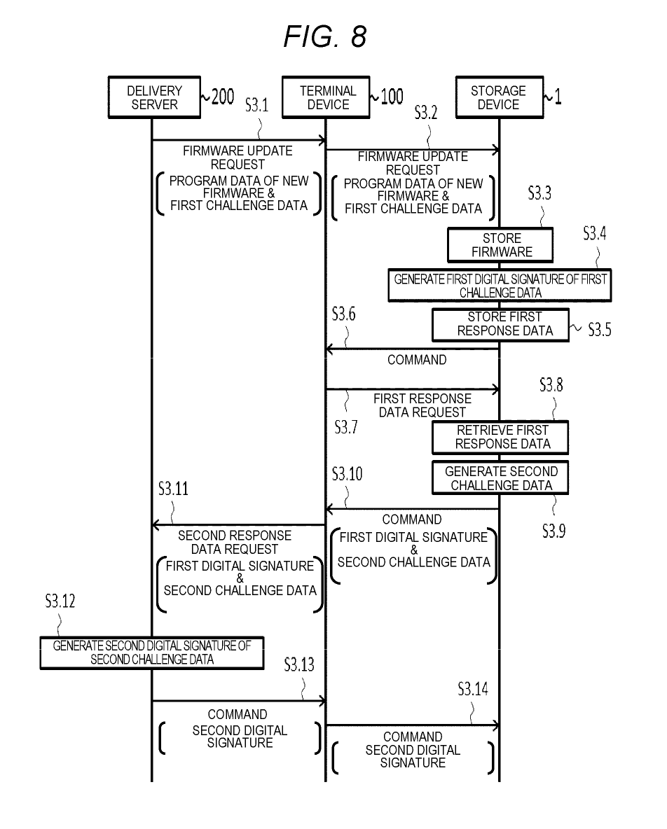

FIG. 8 is a sequence diagram illustrating a firmware update operation according to the third embodiment. The firmware update operation to update the firmware of the terminal device 100 according to the third embodiment will be hereinafter described with reference to FIG. 8.

When the firmware of the terminal device 100 is updated, first the delivery server 200 issues a firmware update request for the terminal device 100 (S3.1). At this time, the delivery server 200 transmits update data to the terminal device 100 along with the firmware update request. In the third embodiment, the update data includes program data of the new firmware, and first challenge data.

The terminal device 100 transmits the firmware update request received from the delivery server 200 to the storage device 1 using, for example, a dedicated command (S3.2). The update data which is received through the data receiving section 20 of the storage device 1 is written to the firmware storage area 40 of the storage device 1, and the program data of the new firmware is stored in the firmware storage area 40 (S3.3).

Subsequently, in the storage device 1, the digital signature generation section 60 generates a first digital signature of the first challenge data, which is included in the update data, by using the private key stored in advance in the secret key storage area 70 (S3.4). The generated first digital signature and the first challenge data are stored in the response data storage area 50 as first response data (S3.5). The storage device 1 completes processing according to the firmware update request, and issues a command to the terminal device 100 through the data transmission section 10 (S3.6).

In response to receiving a command from the storage device 1, the terminal device 100 issues a first response data request to the storage device 1 (S3.7).

In response to receiving the first response data request through the data receiving section 20, the storage device 1 retrieves the first response data from the response data storage area 50 (S3.8), and generates second challenge data (S3.9). The storage device 1 transmits the first response data and the second challenge data to the terminal device 100 through the data transmission section 10 (S3.10).

In the third embodiment, the storage device 1 transmits not only the first digital signature but also the second challenge data, to the terminal device 100. Thus, the first response data that the terminal device 100 receives from the storage device 1, includes the first digital signature of the first challenge data, and the second challenge data. In this embodiment, authentication of the first digital signature included in the first response data is carried out by the delivery server 200 using a public key of the storage device 1, similarly to the first embodiment.

Further, in response to receiving the command from the storage device 1, the terminal device 100 issues a second response data request to the delivery server 200 (S3.11). At this time, the first response data is also transmitted from the terminal device 100 to the delivery server 200.

When the delivery server 200 receives the second response data request from the terminal device 100, the digital signature generating section 203 of the delivery server 200 generates a second digital signature of the second challenge data which is included in the first response data, using the private key of the delivery server 200 stored in advance in the secret key storage area 202 thereof (S3.12). The generated second digital signature is transmitted to the terminal device 100 as second response data (S3.13).

The terminal device 100 which receives the second response data transmits a dedicated command, including the second digital signature, to the storage device 1 (S3.14).

The storage device 1 which receives the second digital signature from the terminal device 100 performs authentication of the second response data which is transmitted according to the command. Specifically, the authentication section 35 decrypts the second digital signature in the second response data using the public key of the delivery server 200 to obtain the second challenge data and confirm that it matches the second challenge data transmitted to the delivery server 200 with the second response data request, so the storage device 1 may confirm that the authentication which is performed in the delivery server 200 is successful.

As described above, in the third embodiment, the challenge and response authentication is mutually performed between the delivery server 200 and the storage device 1 through the terminal device 100. In the present embodiment, when the response to the first challenge data that is received from the delivery server 200 is returned, the storage device 1 transmits the second challenge data to the delivery server 200, and receives the response to the second challenge data from the delivery server 200.

In other words, in the present embodiment, the delivery server 200 and the storage device 1 each perform the challenge and response authentication.

Thus, as receiving the response to the second challenge data from the delivery server 200, the storage device 1 may confirm that the firmware update of the terminal device 100 is correctly performed.

Furthermore, when there is a problem in the result of the challenge and response authentication, for example, information indicating that the firmware update fails is output to the terminal device 100, whereby a user which uses the terminal device 100 may know that the firmware update fails. At this time, it is possible to notify the user of the failure of the firmware update, by showing the information on a display of the terminal device 100, for example.

In addition, when there is a problem in the result of the challenge and response authentication, the terminal device 100 may be configured to not be able to perform (disable) the firmware which is stored in the storage device 1, when the terminal device 100 is activated thereafter.

### Fourth Embodiment

The challenge and response authentication of the delivery server 200 and the storage device 1 which is described in the first embodiment to the third embodiment is not limited only to firmware updates.

In the fourth embodiment, the delivery server 200 determines whether or not a patch to an OS which is executed by the terminal device 100 has been properly performed, through the challenge and response authentication of the storage device 1.

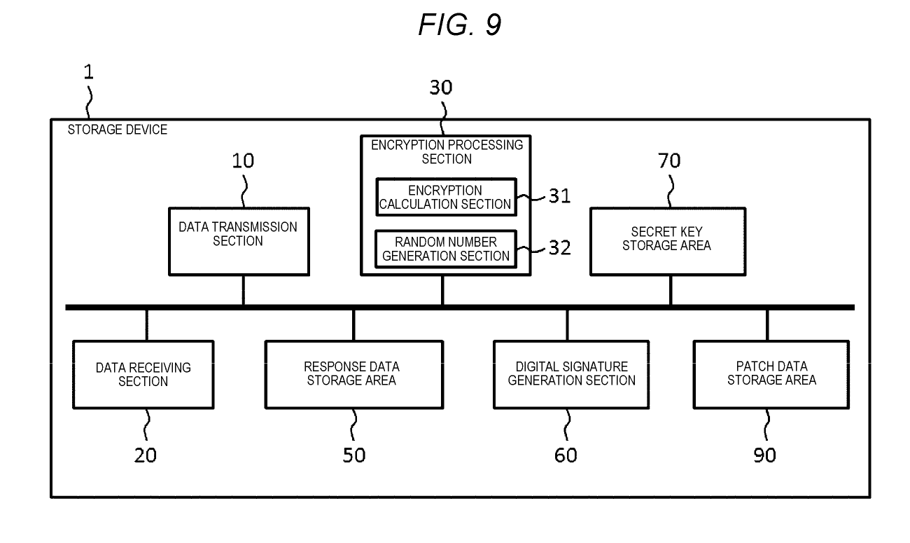

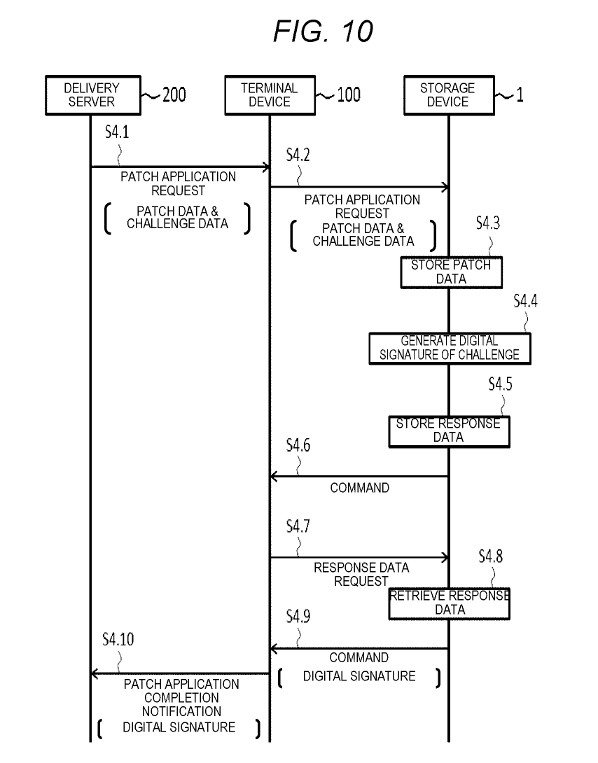

FIG. 9 is a block diagram of a storage device 1 according to a fourth embodiment. FIG. 10 is a sequence diagram illustrating a patch operation according to the fourth embodiment. The patch operation to apply the patch to the terminal device 100 will be hereinafter described with reference to FIG. 9 and FIG. 10.

The delivery server 200 issues a patch request with respect to the terminal device 100 (S4.1). Meanwhile, the “patch request” includes patch data and challenge data.

The terminal device 100 transmits the patch request received from the delivery server 200 to the storage device 1, using, for example, a dedicated command (S4.2). The patch data that the storage device 1 receives is written to a patch data storage area 90 of the storage device 1 (S4.3).

Subsequently, in the storage device 1, the digital signature generation section 60 generates a digital signature of the challenge data, using the private key of the storage device 1 which is stored in advance in the secret key storage area (S4.4). The generated digital signature and the challenge data are stored in the response data storage area 50 as response data (S4.5). The storage device 1 completes processing according to the patch application request, and returns a command to the terminal device 100 (S4.6).

In response to receiving the command from the storage device 1, the terminal device 100 issues a response data request with respect to the storage device 1 (S4.7).

In response to receiving the response data request, the storage device 1 retrieves the response data (S4.8), and transmits the response data (command) to the terminal device 100 (S4.9).

In response to receiving the command from the storage device 1, the terminal device 100 transmits a patch completion notification to the delivery server 200 together with the response data (S4.10). By performing authentication of the digital signature of the received response data using a public key of the storage device 1, the delivery server 200 may confirm that the patch operation in the terminal device 100 has successfully completed.

Meanwhile, as described in the second embodiment, the delivery server 200 may have a configuration in which, when the delivery server 200 starts the patch application, the timer is set, and when the response data is not returned from the storage device 1 within a predetermined time, so that the delivery server 200 can confirm that the patch application is correctly executed.

In addition, as described in the third embodiment, when the storage device 1 returns the response data, new challenge data which is arbitrarily generated by the storage device 1 may be transmitted to the delivery server 200 together with the response data, and new response data with respect to the new challenge data may be transmitted to the storage device 1. According to this configuration, the delivery server 200 and the storage device 1 may mutually perform the challenge and response authentication.

As described above, according to the present embodiment, the delivery server 200 may confirm that the patch operation in the terminal device 100 has successfully completed.

In addition, when the terminal device 100 receives unauthorized access and performs unauthorized operation, the delivery server 200 or the storage device 1 may determine that the patch operation in the terminal device 100 has not successfully completed, whereby it is possible to rapidly perform countermeasure, such as disconnection of the terminal device 100 from the IP network 300, or initialization of the terminal device 100 by a maintenance person.

Meanwhile, in the first embodiment to the fourth embodiment, the delivery server 200 transmits the program data of the firmware or the patch data to the storage device 1 through the terminal device 100, but data to be handled is not limited to this, and, for example, may be parameter data or the like.

In addition, in the first embodiment to the fourth embodiment, various commands (command, response) are exchanged between the delivery server 200, the terminal device 100, and the storage device 1, through an interface (I/F). However, a response command may be a static signal using other coupling terminals, not the I/F.

Furthermore, the storage device 1 may have a configuration in which the firmware is not rewritten immediately after the program data of the firmware is received. Instead, the firmware may be temporarily stored in a volatile memory such as a RAM, and updated after the challenge and response authentication is completed. In the first embodiment, the firmware is not rewritten until the delivery server 200 notifies the terminal server 100 that the delivery server 200 has confirmed the digital signature. In the third embodiment, the firmware is not rewritten until the storage device 1 confirms that the digital signature received from the delivery server 200 contains the second challenge data.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A terminal for which update processing is carried out through communication with an external device connected therewith over a network, comprising:
a processor configured to receive an update request from the external device, the update request including update data and challenge data; and
a storage device in which original data to be updated and a private key are stored, the storage device being configured to update the original data using the update data and generate a digital signature of the challenge data using the private key,
wherein the processor is further configured to transmit the digital signature of the challenge data to the external device as a completion notification of the update processing.

2. The computing system according to claim 1, wherein the external device confirms that the update processing is successful by decrypting the digital signature using a public key of the storage device and confirming that the decrypted data matches the challenge data.

3. The computing system according to claim 1, wherein the storage device is configured to defer updating the original data using the update data until notification of successful authentication is received by the terminal from the external device.

4. The computing system according to claim 1, wherein the storage device is further configured to:
generate a second challenge data, wherein the second challenge data is transmitted to the external device together with the digital signature, and
decrypt a digitally-signed challenge data returned from the external device using a public key of the external device and confirm that the decrypted data matches the second challenge data.

5. The computing system according to claim 4, wherein the storage device is configured to not update the original data using the update data if the decrypted data does not match the second challenge data.

6. The computing system according to claim 1, wherein the firmware is disabled if the update processing is not successfully completed.

7. The computing system according to claim 1, wherein the update data comprises an update to a firmware of the terminal.

8. The computing system according to claim 1, wherein the update data comprises a patch to an operating system software of the terminal.

9. A server for performing update processing on a terminal through communications with the terminal over a network, comprising:
a processor configured to transmit an update request to the terminal, the update request including update data and challenge data, wherein
the processor, upon receipt of a completion notification of the update processing from the terminal, decrypts a digital signature in the completion notification, and confirms successful completion of the update processing if the completion notification is received within a predetermined amount of time after the transmission of the update request and the decrypted data matches the challenge data.

10. The server according to claim 9, wherein the server transmits a notification of successful completion of the update processing to the terminal in response to which the terminal applies the update data, or a notification of unsuccessful completion of the update processing to the terminal in response to which the terminal does not apply the update data.

11. The server according to claim 9, further comprising a private key storage area, wherein the process is further configured to:
generate digital signature of a second challenge data included in the completion notification using a private key of the server stored in the private key storage area, and
transmit the digital signature of a second challenge data to the terminal.

12. The server according to claim 11, wherein the terminal confirms that the update processing is successful by decrypting the digital signature of the second challenge data using a public key of the server and confirming that the decrypted data matches the second challenge data.

13. The server according to claim 9, wherein the update data comprises an update to a firmware of the terminal.

14. The server according to claim 9, wherein the update data comprises a patch to an operating system software of the terminal.

15. A method for securely updating software or firmware of a terminal having a storage device in which the software or firmware is stored, comprising:
transmitting an update request including update data and challenge data from a server to the terminal;
generating a digital signature for the challenge data using a private key of the storage device;
transmitting the digital signature from the terminal to the server;
decrypting the digital signature using a public key of the storage device; and
applying the update data to the software or firmware based on a comparison between the decrypted data and the challenge data.

16. The method according to claim 15, wherein
the update data is applied to the software or firmware if the decrypted data and the challenge data match; and
the firmware or software subject to the update is disabled if the decrypted data and the challenge data do not match.

17. The method according to claim 15, further comprising:
generating a second challenge data at the storage device and transmitting the second challenge data from the terminal to the server together with the digital signature;
digitally signing the second challenge data at the server using a private key of the server and transmitting the digitally-signed second challenge data to the terminal; and
decrypting the digitally-signed second challenge data at the storage device using a public key of the server and comparing the decrypted data with the second challenge data; and
applying the update data to the software or firmware also based on whether or not the decrypted data matches the second challenge data.

18. The method according to claim 15, further comprising:
starting a timer when the update request is transmitted; and
applying the update data to the software or firmware only if the server receives the digital signature from the terminal when the timer is less than a predetermined value.

19. The method according to claim 15, wherein the update data comprises an update to a firmware of the terminal that is stored in the storage device.

20. The method according to claim 15, wherein the update data comprises a patch to an operating system software of the terminal that is stored in the storage device.
